(19) United States
(12) Patent Application Publication
(10) Pub. No.: US 2008/0100663 A1
(43) Pub. Date: May 1, 2008

(54) INKJET IMAGE FORMING APPARATUS AND PRINT METHOD USING THE SAME

(75) Inventors: You-seop LEE, Yongin-si (KR); Bang-weon Lee, Yongin-si (KR); Vassili Leniachine, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/776,575

(22) Filed: Jul. 12, 2007

(30) Foreign Application Priority Data
Oct. 30, 2006 (KR) 2006-105549

(51) Int. Cl. B41J 2/145

(52) U.S. Cl. 347/40

(57) ABSTRACT

An inkjet image forming apparatus and a print method using the same. The inkjet image forming apparatus includes an inkjet printhead cartridge having one or more nozzle units and a plurality of nozzles arranged over its length and disposed in nozzle units corresponding to a width of a print medium in a main scanning direction, and a shifting unit to move the nozzle units in the main scanning direction within the inkjet cartridge to eject ink, wherein the inkjet printhead cartridge is fixed with respect to the main scanning direction, and the nozzles are divided into respective ones of the nozzle units.

### CROSS-REFERENCE TO RELATED APPLICATIONS

This application claims priority under 35 U.S.C. §119(a) from Korean Patent Application No. 10-2006-0105549, filed on Oct. 30, 2006, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus and a print method using the same, and more particularly, to an inkjet image forming apparatus capable of compensating for a defective nozzle to print at a high resolution, and a print method using the same.

2. Description of the Related Art

An inkjet image forming apparatus prints an image on a print medium by ejecting ink from an inkjet printhead cartridge onto a top surface of the print medium. The inkjet printhead cartridge reciprocates in a direction (hereinafter, referred to as a main scanning direction) perpendicular to a feed direction of the print medium. This type of ink cartridge is called a shuttle type inkjet printhead cartridge. The feed direction of the print medium is called a subsidiary scanning direction, and is perpendicular to the main scanning direction.

On the other hand, an array type inkjet printhead cartridge does not reciprocate, but is fixed with respect to the main scanning direction of the print medium, and only the print medium is fed in the subsidiary scanning direction. An image forming apparatus employing the array type inkjet printhead cartridge has a simple structure and high print speed. However, since the array type inkjet printhead cartridge does not move in the main scanning direction, it is difficult to compensate for any defective nozzles, and a print resolution is limited by a nozzle density.

A conventional array type inkjet printhead cartridge includes a nozzle array having a plurality of nozzles for ejecting ink arranged over its length, which corresponds to a width of the print medium. Therefore, if some of the nozzles are defective, due to electrical or mechanical damage, ink is not ejected normally. Defective nozzles may be weak or missing. When the array type inkjet printhead cartridge prints an image on a print medium, the defective nozzles cause white lines on the printed image along the feed direction, thereby seriously decreasing a print quality.

In one approach to compensate for defective nozzles, nozzles adjacent to the defective nozzles are controlled to eject larger than normal ink droplets to compensate for the defective nozzles. However, this approach cannot sufficiently prevent print quality degradation, since ink droplets are not ejected exactly onto the white lines.

The shuttle type inkjet printhead cartridge can easily compensate for defective nozzles by ejecting ink exactly onto the white lines from other normal nozzles while moving the shuttle type inkjet printhead cartridge in the main scanning direction. Similarly, to compensate for the defective nozzles of the array type inkjet printhead cartridge, it is necessary to eject ink exactly onto the white lines by varying the ink ejecting positions onto the print medium along the main scanning direction.

The print resolution of the array type inkjet printhead cartridge is determined by the number of nozzles per unit length. However, to structurally increase the nozzle density of the array type inkjet printhead cartridge is very expensive and causes many manufacturing problems. On the other hand, although the shuttle type inkjet printhead cartridge has the same problems for increasing its nozzle density, the shuttle type inkjet printhead cartridge can move to change the ink ejecting positions of the nozzles in the main scanning direction. Therefore, the print quality of the shuttle type inkjet printhead cartridge can be increased by controlling the ink ejecting positions of the nozzles without structurally increasing the nozzle density. Thus, it is necessary to vary the ink ejecting positions in the main scanning direction to increase the density of ejected ink and thereby increase the print resolution of the array type inkjet printhead cartridge.

Also, when ink droplets of different color are ejected onto a same portion and thereby mixed in a liquid state to print color images, color contrast may be reduced. This color print quality deterioration may be solved by ejecting ink droplets of a certain color onto a desired region of a print medium with a low resolution and allowing the droplets to be absorbed into the print medium and dry, and then ejecting ink droplets of another color on another separate region. This is called a multi-printing method. Therefore, it is necessary to vary the ink ejecting positions in the main scanning direction in order to improve the color print quality.

### SUMMARY OF THE INVENTION

The present general inventive concept provides an inkjet image forming apparatus having an array type inkjet printhead cartridge that can vary an ink ejecting position in a main scanning direction, to compensate for a defective nozzle and improve a print resolution and color print quality, and a print method using the same.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing an inkjet image forming apparatus, including an inkjet printhead cartridge having one or more nozzle units and a plurality of nozzles arranged over a length of the inkjet cartridge and disposed in the nozzle units corresponding to a width of a print medium in a main scanning direction, and a shifting unit to move the nozzle units in the main scanning direction within the inkjet printhead cartridge to eject ink, wherein the inkjet printhead cartridge is fixed with respect to the main scanning direction, and the nozzles are divided into respective ones of the nozzle units.

The shifting unit periodically may move the nozzle units in opposite directions with respect to the main scanning direction.

The nozzle units may include a first nozzle unit and a second nozzle unit spaced apart from each other in a subsidiary scanning direction perpendicular to the main scanning direction.

The first and second nozzle units may have a same number of ink ejections per unit time at a same ink ejecting position even when the first and second nozzle units move with an amplitude of half or less a distance between the first and second nozzle units moving in a same direction.

The inkjet image forming apparatus may further include first head chips formed in the first nozzle unit, each of the first head chips including a first portion of the plurality of nozzles, and second head chips formed in the second nozzle unit, each of the second head chips including a second portion of the plurality of nozzles, wherein the first and second head chips are arranged in a zigzag pattern.

The shifting unit may include a first shifting unit to move the first nozzle unit, and a second shifting unit to move the second nozzle unit.

The first shifting unit may include a first actuator to push the first nozzle unit and a first guide unit to guide the first nozzle unit, and the second shifting unit may include a second actuator to push the second nozzle unit and a second guide unit to guide the second nozzle unit.

The first shifting unit may further include a first elastic member to elastically bias the first nozzle unit toward the first actuator, and the second shifting unit may further include a second elastic member to elastically bias the second nozzle unit toward the second actuator.

The shifting unit may include an actuator to push the first nozzle unit in a first direction, a link to push the second nozzle unit in the opposite direction to the first direction according to movement of the first nozzle unit, and a guide unit to guide the first and second nozzle units.

The shifting unit may further include an elastic member to elastically bias the second nozzle unit toward the link.

The actuator may be a rotating cam with a protrusion formed on part of its circumference, a crankshaft to convert rotation into a linear movement, a voice coil actuator including a magnet and a voice coil, or a piezoelectric actuator.

The foregoing and/or other aspects and utilities of the present general inventive concept are also achieved by providing a print method of an inkjet image forming apparatus including an inkjet printhead cartridge having a plurality of nozzles disposed in movable nozzle units and arranged over a length of a width of a print medium in a main scanning direction, the method including fixing the inkjet printhead cartridge with respect to the main scanning direction, and moving each of the nozzle units in the main scanning direction with respect to the inkjet printhead cartridge to eject ink.

The moving of the nozzle units may include moving the nozzle units in opposite directions.

The nozzle units may include a first nozzle unit and a second nozzle unit spaced apart from each other in a subsidiary scanning direction perpendicular to the main scanning direction.

The first and second nozzle units may have a same number of ink ejections per unit time at a same ink ejecting position even when the first and second nozzle units move with an amplitude of half or less of a distance between the first and second nozzle units moving in a same direction.

The foregoing and/or other aspects and utilities of the present general inventive concept are also achieved by providing an inkjet image forming apparatus, including an inkjet printhead cartridge having a plurality of nozzles disposed in at least one movable nozzle unit, to form an image on a print medium, a feed roller to feed the print medium toward the inkjet printhead cartridge, a platen to guide the print medium and to keep the print medium at a predetermined distance from the printhead cartridge, and a drive unit to drive the feed roller, wherein the inkjet printhead cartridge is fixed with respect to a main scanning direction of the print medium and the at least one nozzle unit moves in the main scanning direction.

The inkjet printhead cartridge may further include a shifting unit to move the at least one nozzle unit in the main scanning direction.

The shifting unit may reciprocate the at least one nozzle unit in the main scanning direction.

The shifting unit may include an actuator to move each nozzle unit in a first direction, an elastic member to elastically bias each nozzle unit in a second direction opposite the first direction, and a guide to guide the movement of the at least one nozzle unit.

The at least one movable nozzle unit may include a first movable nozzle unit and a second movable nozzle unit, and the shifting unit may include an actuator to move the first movable nozzle unit in a first direction, a linking unit to move the second movable nozzle unit in a direction opposite to the first direction according to a movement of the first movable unit, an elastic member to elastically bias the second movable nozzle unit in towards the linking unit, and a guide to guide the movement of the first and second nozzle units.

The at least one movable nozzle unit may include a first movable nozzle unit and a second movable nozzle unit, and the nozzles may be disposed in head units, and each of the first and second movable nozzle units may include at least one head unit.

The at least one movable nozzle unit may include a first movable nozzle unit and a second movable nozzle unit, and the first and second movable nozzle units each may include a plurality of head units, and the head units may be arranged in a zigzag pattern.

The at least one movable nozzle unit may include a first movable nozzle unit and a second movable nozzle unit, and the first and second movable nozzle units may reciprocate with an amplitude equal one-half or less a distance between corresponding head units of the first and second movable nozzle units.

The at least one nozzle unit may move in the main scanning direction to compensate for a defective nozzle.

The at least one nozzle unit may move in the main scanning direction to decrease a distance between positions at which ink is ejected through the nozzles to increase a print resolution.

The at least one movable nozzle unit may include first and second movable units movably disposed with respect to each other within the inkjet printhead cartridge.

The at least one movable nozzle unit may be movably disposed in the inkjet printhead cartridge.

The foregoing and/or other aspects and utilities of the present general inventive concept are also achieved by providing an inkjet printhead cartridge usable in an array type image forming apparatus, including a body, a plurality of nozzle units movably disposed in the body, and a plurality of head units having nozzles disposed therein mounted on the nozzle units, and disposed to move with respect to the body.

The inkjet printhead may further include a shifting unit to move the nozzle units with respect to the body.

The inkjet printhead may further include a shifting unit to move the nozzle units with respect to each other.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a perspective view illustrating an inkjet image forming apparatus according to an embodiment of the present general inventive concept;

FIG. 2 is a perspective view illustrating an inkjet printhead cartridge according to an embodiment of the present general inventive concept;

FIG. 3 is a plan view illustrating a head chip according to an embodiment of the present general inventive concept;

FIGS. 4 through 8 illustrate a shifting unit according to an embodiment of the present general inventive concept;

FIG. 9 illustrates traces of ink ejecting positions of nozzles that are moved by a shifting unit according to an embodiment of the present general inventive concept;

FIG. 10 illustrates an inkjet printhead cartridge reciprocating with an amplitude corresponding to ½ of a head chip; and

FIG. 11 illustrates nozzle units reciprocating with an amplitude corresponding to ¼ of a head chip according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

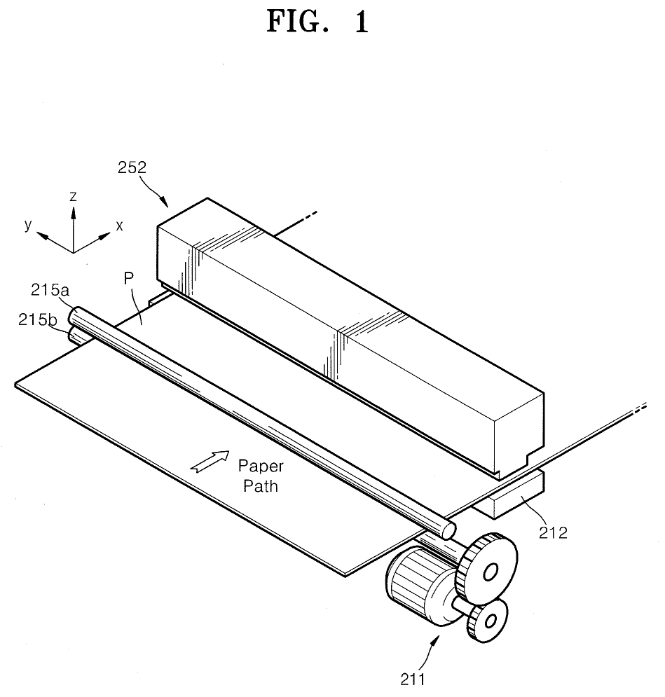

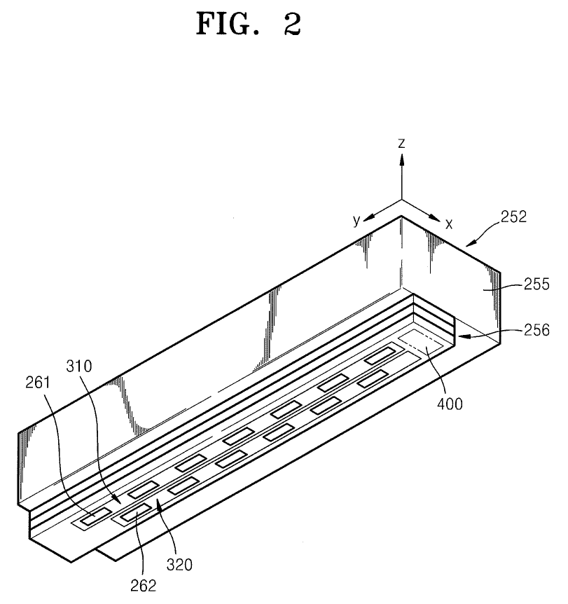

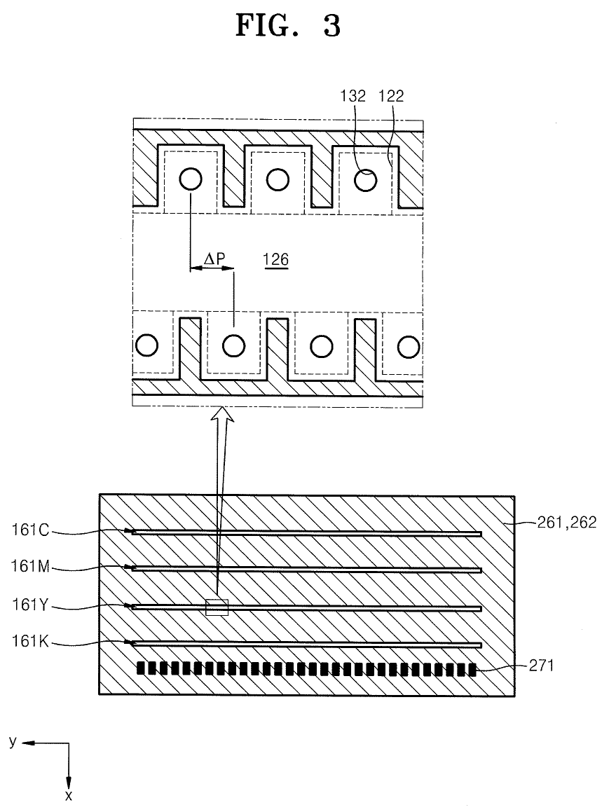

FIG. 1 is a perspective view illustrating an inkjet image forming apparatus according to an embodiment of the present general inventive concept. FIG. 2 is a perspective view illustrating an inkjet printhead cartridge according to an embodiment of the present general inventive concept. FIG. 3 is a plan view illustrating a head chip according to an embodiment of the present general inventive concept.

Referring to FIGS. 1 through 3, the inkjet image forming apparatus according to an embodiment of the present general inventive concept may be a line printing type image forming apparatus and include one or more arrays of nozzle units, each array of the nozzle unit having head chips 261 or 262 each having a plurality of nozzles 132 arranged over a length of an array type inkjet cartridge 252, corresponding to a width of a print medium P, to print an image in a line-by-line manner. The print medium P is fed in an x-axis direction (the length direction of the print medium P, hereinafter, referred to as a subsidiary scanning direction), and the width direction of the print medium P is denoted by a y-axis (hereinafter, referred to as a main scanning direction).

The inkjet image forming apparatus may include the array type inkjet printhead cartridge 252, a platen 212, feed rollers 215a and 215b, and a driving unit 211. The inkjet printhead cartridge 252 may include the head chips 261 and 262 having the plurality of nozzles 132, and may be fixedly mounted on a main body of the inkjet image forming apparatus. The platen 212 guides the print medium P while keeping the print medium P at a predetermined distance from the printhead cartridge 252. The feed rollers 215a and 215b feed the print medium P toward the inkjet printhead cartridge 252, and the driving unit 211 drives the feed rollers 215a and 215b.

The inkjet printhead cartridge 252 may include a body 255 that may include an ink tank (not illustrated) to store inks of different colors, a portion on which the head chips 261 and 262 corresponding to the width direction of the print medium P, and an ink channel unit 256 to supply the ink stored in the ink tank to the head chips 261 and 262.

For example, four nozzle arrays 161C, 161M, 161Y and 161K can be formed in the head chips 261 and 262 to respectively eject cyan, magenta, yellow, and black ink, to print color images. Alternatively, the head chips 261 and 262 may eject single color ink to print monochromatic images. The ink channel unit 256 constitutes an ink passage from the ink tank to a rear of the head chips 261 and 252. The ink channel unit 256 can be formed by injection-molding liquid crystal polymer (LCP) in order to increase thermal stability, durability, and productivity.

The head chips 261 and 262 can be connected to a control unit (not illustrated) of the inkjet image forming apparatus through a flexible printed circuit (FPC) (not illustrated) and receive a driving signal and power to eject ink. The head chips 261 and 262 may include a pad unit 271 electrically connected to the FPC to receive the driving power and control signal.

In the current embodiment, the head chips 261 and 262 are spaced apart from each other and arranged in a zigzag pattern along main and subsidiary scanning directions, as illustrated in FIG. 2. However, the present general inventive concept is not limited thereto, and although not illustrated, different numbers of head chips and different arrangements can be used. For example, one head chip or a plurality of head chips may be disposed on the inkjet printhead cartridge in a straight line over a length corresponding to the width of the print medium P.

When the head chips 261 and 262 are arranged in a zigzag pattern, as illustrated in FIG. 2, the control unit measures an x-axis deviation of the head chips 261 and 262 and the feeding distance of the print medium P, and thereby synchronizes the ink ejecting positions of the nozzle arrays 161C, 161M, 161Y and 161K that may be included in each of the head chips 261 and 262 with one another in an x-axis direction. For example, although the black nozzle arrays 161K formed in each of the head chips 261 and 262 are not located in the same straight line in a y-axis direction, as the ink ejecting positions in an x-axis direction are synchronized based on the x-axis deviation of the head chips 261 and 262 and the feed distance of the print medium P, ink dots may be printed in a straight line parallel to the y-axis onto the print medium P. A nozzle pitch ΔP, that indicates a distance between adjacent nozzles 132, determines the print resolution of the inkjet image forming apparatus. If the nozzle pitch ΔP is 1/600 inch, the print resolution of the inkjet image forming apparatus may be 600 dpi (dots per inch) or higher according to a method to control the inkjet image forming apparatus.

Ink stored in the ink tank can be filled into an ink chamber 122 through the ink channel unit 256, the rear of the head chips 261 and 262, and an ink feed hole 126. Ink can be ejected by generating bubbles in ink in the ink chamber 122 by heat, and an expansion of the bubbles can eject the ink through the nozzles 132. Alternatively, other methods to eject ink through the nozzles 132 may be used, for example, ink may be ejected through the nozzles 132 by a pressure generated by a piezoelectric member in the ink chamber 122.

Referring to FIG. 2, the plurality of nozzles 132 can be divided into a first nozzle unit 310 and a second nozzle unit 320. Although not illustrated, three or more nozzle units may also be provided. When the nozzles 132 are divided into an N number of nozzle units 310 and 320 (N is a positive number), the nozzle units 310 and 320 move in different directions along the main scanning direction with respect to the printhead cartridge 252. Thus, N may be 2 or higher.

According to an embodiment of the present general inventive concept, the inkjet printhead cartridge 252 is fixed with respect to the main scanning direction, and the nozzle units 310 and 320 are moved in the main scanning direction by a shifting unit 400. Each of the nozzle units 310 and 320 may include at least one head chip 261 or 262, and the head chips 261 and 262 include the nozzles 132 to eject ink. When the nozzles 132 are grouped into a first nozzle unit 310 and a second nozzle unit 320, the first nozzle unit 310 includes at least a first head chip 261, and the second nozzle unit 320 includes at least a second head chip 262. The first nozzle unit 310 and the second nozzle unit 320 may move with respect to each other.

When a particular nozzle among the nozzles 132 cannot eject ink normally it is defined as a defective nozzle. The defective nozzle may generate a missing line that extends in the subsidiary scanning direction and is represented as a blank line. Various methods have been proposed to compensate for the missing line.

For example, when a normal nozzle is moved to a position of a defective nozzle to eject ink by moving the inkjet printhead cartridge itself, since the inkjet printhead cartridge has a relatively large inertia, a volume of a mechanism to move the inkjet printhead cartridge increases. Also, as a movement distance and a movement time of the inkjet printhead cartridge increase, a print speed decreases and vibration and noise increase. Since the vibration and noise of the inkjet printhead cartridge are directly affected by the movement distance of the head chip, it is necessary to minimize a movement distance of the head chip.

In the present general inventive concept, this problem is solved by moving the nozzle units 310 and 320 instead of the inkjet printhead cartridge 252. The movement distance of the head chips 261 and 262 is reduced and the inertia of the movable structure is reduced, thereby reducing malfunction due to the vibration of the inkjet printhead cartridge and increasing the print speed.

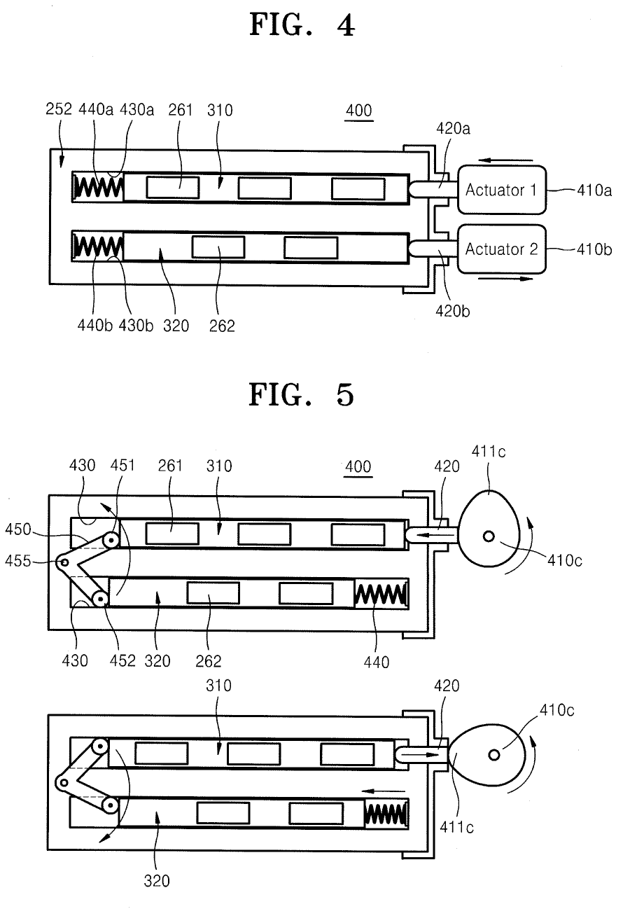

FIGS. 4 through 8 illustrate a shifting unit 400 according to an embodiment of the present general inventive concept.

Referring to FIG. 4, the shifting unit 400 can be provided as a first shifting unit to shift the first nozzle unit 310 and a second shifting unit to shift the second nozzle unit 320. The first shifting unit may include a first actuator 410a to push the first nozzle unit 310, and a first guide unit 430a to guide a movement of the first nozzle unit 310. The second shifting unit may include a second actuator 410b to push the second nozzle unit 320, and a second guide unit 430b to guide a movement of the second nozzle unit 320. The first and second actuators 410a and 410b may be of any type to linearly move the nozzle units.

End portions of the first and second nozzle units 310 and 320 can be connected respectively to the first and second actuators 410a and 410b by contacting first and second push bars 420a and 420b, respectively. The first and second nozzle units 310 and 320 can be elastically biased toward the first and second actuators 410a and 410b by first and second elastic members 440a and 440b contacting other portions of the first and second nozzle units 310 and 320. The first and second guide units 430a and 430b guide the linear movement of the first and second nozzle units 310 and 320. For example, the first and second guide members 430a and 430b can have a slot shape into which the first and second nozzle units 310 and 320 are movably inserted.

Referring to FIG. 5, according to another embodiment of the present general inventive concept, the shifting unit 400 can include an actuator 410c to push the first nozzle unit 310 in a first direction, a link 450 to push the second nozzle unit 320 in an opposite direction to the first direction according to the movement of the first nozzle unit 310, and guide units 430 to guide the movement of the first and second nozzle units 310 and 320. In FIG. 5, the first direction is to the left and the opposite direction is to the right, but the present general inventive concept is not limited thereto, and various changes may be made therein. The shifting unit 400 may further include an elastic member 440 to elastically bias the second nozzle unit 320 toward the link 450, and the first nozzle unit 310 toward the actuator 410c by movement of the link.

For example, the link 450 rotates around a pivot 455, and includes a first contact portion 451 contacting the first nozzle unit 310 and a second contact portion 452 contacting the second nozzle unit 320. The actuator 410 is connected to the first nozzle unit 310 by a push bar 420.

While FIG. 5 illustrates the actuator 410 as a rotating cam 410c with a protrusion 411c formed on part of its circumference, the present general inventive concept is not limited thereto, and the shifting unit 400 may include other elements to move the first and second nozzle units 310 and 320. For example, the shifting unit 400 may also include a crankshaft 410d to convert rotation into a linear movement as illustrated in FIG. 6, a voice coil actuator 410e including a magnet 411e and a voice coil 412e as illustrated in FIG. 7, or a piezoelectric actuator 410f as illustrated in FIG. 8.

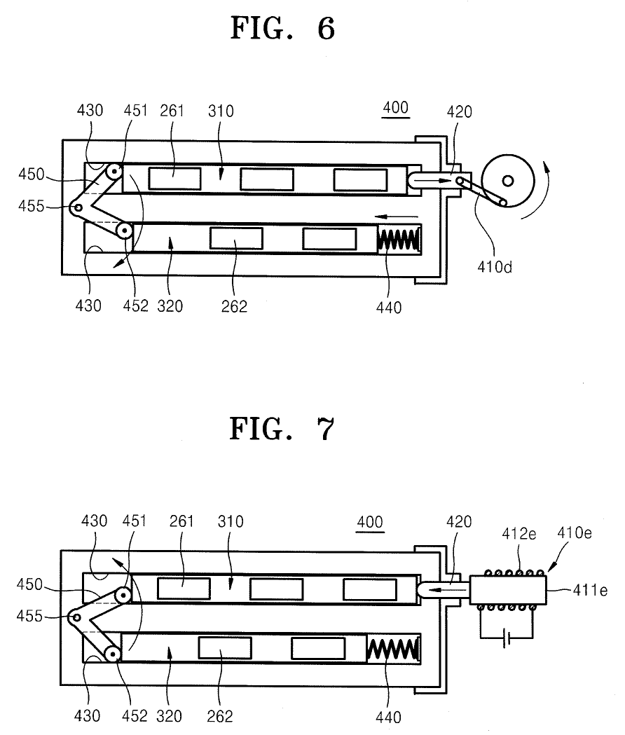

FIG. 9 illustrates traces of ink ejecting positions of nozzles that are moved by the shifting unit 400. As described above, the inkjet printhead cartridge 252 is fixed, and the first and second nozzle units 310 and 320 move in the main scanning direction, and thereby the ink ejecting positions of the nozzles 132 move in the main scanning direction. Therefore, according to the present general inventive concept, a normal nozzle can be moved to eject ink in the position of a defective nozzle, thereby compensating for the defective nozzle, or a nozzle can be additionally moved to eject ink between two adjacent nozzles, thereby improving a print resolution. Also, color contrast can be improved by ejecting ink of one color in a position adjacent to the position where ink of another color is ejected to print color images.

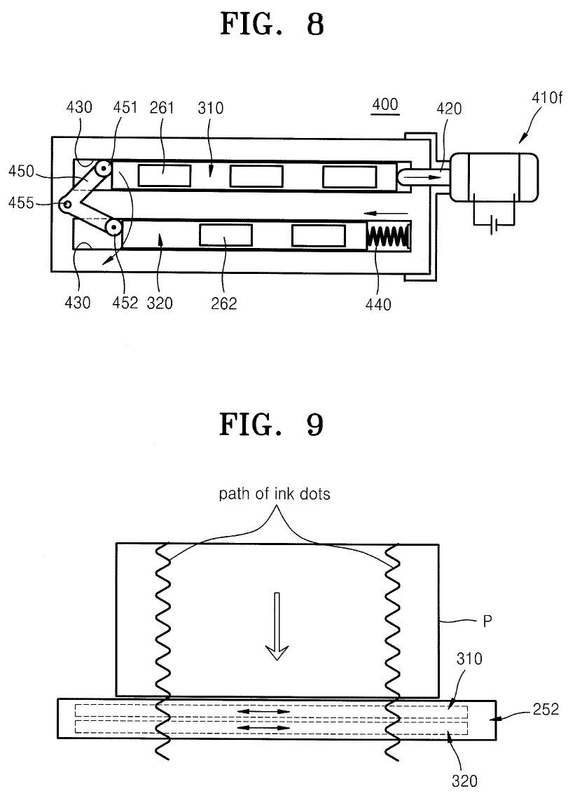

FIG. 10 illustrates an inkjet printhead cartridge reciprocating with an amplitude corresponding to ½ of a head chip. FIG. 10 is for comparison and illustration purposes, that is, FIG. 10 illustrates a case where the entire inkjet printhead cartridge periodically shuttles in the main scanning direction with an amplitude ΔL1 corresponding to ½ of a length of head chips 2610 and 2620 mounted thereon with respect to the main body of the inkjet image forming apparatus. The amplitude ΔL1 of the inkjet printhead cartridge corresponding to ½ of the length of the head chips 2610 and 2620 is just an example, and the inkjet cartridge may reciprocate in the main scanning direction by other values. In FIG. 10, each of the head chips 2610 and 2620 includes four nozzles for convenience of description.

Reference numeral II represents the inkjet printhead cartridge located at a normal position, reference numeral I represents the inkjet printhead cartridge moved to the left by ΔL1 in the main scanning direction, and reference numeral III represents the inkjet printhead cartridge moved to the right by ΔL1 in the main scanning direction. It is assumed that ink is ejected once when the inkjet printhead cartridge is located at the normal position (position II), once at position I, and once at position III.

Here, a numbers of ink dots ejected for a section “A” are illustrated in a grid at a lower portion of FIG. 10. A first row of the grid represents a total number of ink dots fired corresponding to four columns of section “A”, the second row represents a number of ink dots ejected from the upper head chip 2610 per column, and the third row represents the number of ink dots ejected from the lower head chip 2620 per column. The head chips 2610 and 2620 are arranged in a zigzag pattern. Therefore, the values of the second row added to the values of the third row equal the values of the first row. Since it is assumed that the inkjet printhead cartridge ejects ink once at each position I, II, and III, the values of the first row are 3, 3, 3, 3, the values of the second row are 1, 1, 2, 2, and the values of the third row are 2, 2, 1, 1. While the inkjet printhead cartridge shuttles by one period, ink is ejected at the ink ejecting position corresponding to a first column, once from the upper head chip 2610 and twice from the lower head chip 2620 for that column position, and thus, ink is ejected a total of three times each column position.

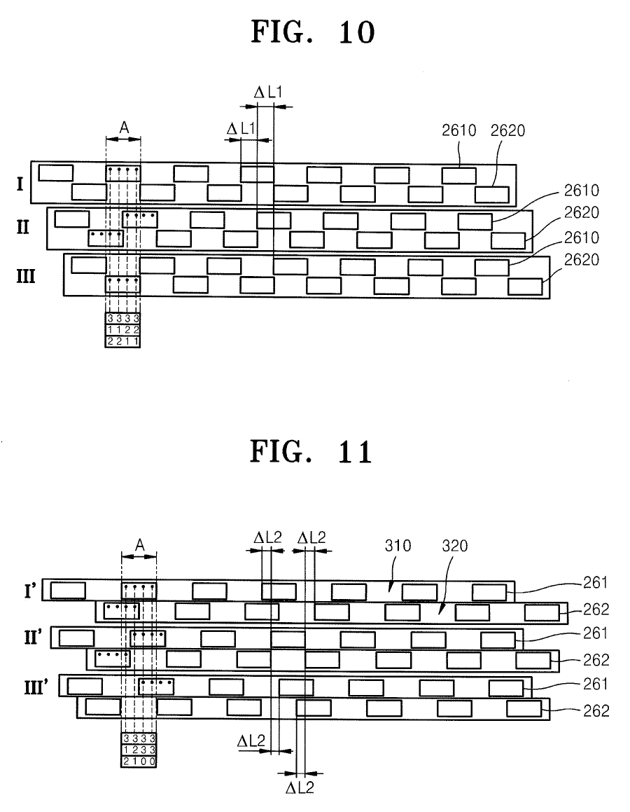

In contrast to FIG. 10, FIG. 11 illustrates a case of an Inkjet printhead having a plurality of nozzle units 310 and 320 reciprocating in the main scanning direction with an amplitude corresponding to ¼ of the head chips 261 and 262, with respect to the main scanning direction according to an embodiment of the present general inventive concept. According to the embodiment illustrated in FIG. 11, the nozzle units 310 and 320 periodically shuttle with an amplitude ΔL2 corresponding to ¼ of the length of the head chips 261 and 262. However, the present general inventive concept is not limited thereto, and the amplitude ΔL2 of the nozzle units 310 and 320 corresponding to ¼ of the length of the head chips 261 and 262 is just an example, and other values may be used.

Reference numeral II′ represents the first and second nozzle units 310 and 320 located at a normal position, reference numeral I′ represents the first nozzle unit 310 moved to the left by a distance ΔL2 and the second nozzle unit 320 moved to the right by a distance ΔL2, and reference numeral III′ represents the first nozzle unit 310 moved to the right by a distance ΔL2 and the second nozzle unit 320 moved to the left by a distance ΔL2. It is assumed that ink is ejected once when the first and second nozzle units 310 and 320 are located at the normal position (position II′), once at position I′, and once at position III′.

Here, the numbers of ink dots ejected for a section “A” are illustrated in a grid at a lower portion of FIG. 11. The first row of the grid represents a total number of ink dots fired corresponding to four columns of section “A, the second row of the grid represents a number of ink dots ejected from nozzles included in the first nozzle unit 310 per column, and a third row of the grid represents a number of ink dots ejected from nozzles included in the second nozzle unit 320 per column. Therefore, the values of the second row added to the values of third row equal the values of the first row. Since it is assumed that the first and second nozzle units 310 and 320 eject ink once at each position I′, II′, and III′, the values of the first row are 3, 3, 3, 3, the values of the second row are 1, 2, 3, 3, and the values of the third row are 2, 1, 0, 0. In FIG. 11, each of the head chips 261 and 262 includes four nozzles for convenience of description.

While the first and second nozzle units 310 and 320 shuttle by one period, ink is ejected at the ink ejecting position corresponding to a first column, once from the first nozzle unit 310 and twice from the second nozzle unit 320, a total of three times for that column position. Ink is ejected at the ink ejecting position corresponding to a second column, twice from the first nozzle unit 310 and once from the second nozzle unit 320, a total of three times for that column position. Ink is ejected at the ink ejecting position corresponding to a third column three times from the first nozzle unit 310, a total of three times for that column position. Ink is ejected at the ink ejecting position corresponding to a fourth column three times from the second nozzle unit 320, a total of three times for that column position.

As a result, compared to the case where the inkjet printhead cartridge 252 is moved with the amplitude ΔL1, as illustrated in FIG. 10, even when the first and second nozzle units 310 and 320 are moved with the amplitude ΔL2, the number of ink ejections per unit time is same for the same column position.

As described above, according to an inkjet image forming apparatus and a print method using the same of the present general inventive concept, a plurality of nozzle units with reduced inertia move with reduced amplitude in opposite directions, thus reducing the vibration of the apparatus and increasing the print speed.

The movement amplitude and the inertia of the nozzle units are reduced, reducing the vibration of the apparatus and increasing the print speed. Also, the first and second nozzle units move in opposite directions, thereby decreasing the inertia load and the vibration of apparatus. The movement of the nozzle units also allows to compensate for defective nozzles, and to improve a print resolution and color contrast.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet image forming apparatus, comprising:
an inkjet printhead cartridge having one or more nozzle units and a plurality of nozzles arranged over a length of the inkjet cartridge and disposed in the nozzle units corresponding to a width of a print medium in a main scanning direction; and
a shifting unit to move the nozzle units in the main scanning direction within the inkjet printhead cartridge to eject ink,
wherein the inkjet printhead cartridge is fixed with respect to the main scanning direction and the nozzles are divided into respective ones of the nozzle units.

2. The inkjet image forming apparatus of claim 1, wherein the shifting unit periodically moves the nozzle units in opposite directions with respect to the main scanning direction.

3. The inkjet image forming apparatus of claim 2, wherein the nozzle units comprise a first nozzle unit and a second nozzle unit spaced apart from each other in a subsidiary scanning direction perpendicular to the main scanning direction.

4. The inkjet image forming apparatus of claim 3, wherein the first and second nozzle units have a same number of ink ejections per unit time at a same ink ejecting position even when the first and second nozzle units move with an amplitude of half or less a distance between the first and second nozzle units moving in a same direction.

5. The inkjet image forming apparatus of claim 3, further comprising:
first head chips formed in the first nozzle unit, each of the first head chips including a first portion of the plurality of nozzles; and
second head chips formed in the second nozzle unit, each of the second head chips including a second portion of the plurality of nozzles,
wherein the first and second head chips are arranged in a zigzag pattern.

6. The inkjet image forming apparatus of claim 3, wherein the shifting unit comprises:
a first shifting unit to move the first nozzle unit; and
a second shifting unit to move the second nozzle unit.

7. The inkjet image forming apparatus of claim 6, wherein:
the first shifting unit comprises:
a first actuator to push the first nozzle unit, and
a first guide unit to guide the first nozzle unit; and
the second shifting unit comprises:
a second actuator to push the second nozzle unit, and
a second guide unit to guide the second nozzle unit.

8. The inkjet image forming apparatus of claim 7, wherein:
the first shifting unit further comprises:
a first elastic member to elastically bias the first nozzle unit toward the first actuator; and
the second shifting unit further comprises:
a second elastic member to elastically bias the second nozzle unit toward the second actuator.

9. The inkjet image forming apparatus of claim 3, wherein the shifting unit comprises:
an actuator to push the first nozzle unit in a first direction;
a link to push the second nozzle unit in an opposite direction to the first direction according to movement of the first nozzle unit; and
a guide unit to guide the first and second nozzle units.

10. The inkjet image forming apparatus of claim 9, wherein the shifting unit further comprises:
an elastic member to elastically bias the second nozzle unit toward the link.

11. The inkjet image forming apparatus of claim 10, wherein the actuator is one of a rotating cam with a protrusion formed on part of its circumference, a crankshaft to convert rotation into a linear movement, a voice coil actuator including a magnet and a voice coil, and a piezoelectric actuator.

12. A print method of an inkjet image forming apparatus including an inkjet printhead cartridge having a plurality of nozzles disposed in movable nozzle units and arranged over a length corresponding to a width of a print medium in a main scanning direction, the method comprising:
fixing the inkjet printhead cartridge with respect to the main scanning direction; and
moving each of the nozzle units in the main scanning direction with respect to the inkjet printhead cartridge to eject ink.

13. The method of claim 12, wherein the moving of the nozzle units comprises periodically moving the nozzle units in opposite directions.

14. The method of claim 13, wherein the nozzle units comprise a first nozzle unit and a second nozzle unit spaced apart from each other in a subsidiary scanning direction perpendicular to the main scanning direction.

15. The method of claim 14, wherein the first and second nozzle units have a same number of ink ejections per unit time at a same ink ejecting position even when the first and second nozzle units move with an amplitude of half or less of a distance between the first and second nozzle units moving in a same direction.

16. An inkjet image forming apparatus, comprising:
an inkjet printhead cartridge having a plurality of nozzles disposed in at least one movable nozzle unit, to form an image on a print medium;
a feed roller to feed the print medium toward the inkjet printhead cartridge;
a platen to guide the print medium and to keep the print medium at a predetermined distance from the printhead cartridge; and
a drive unit to drive the feed roller,
wherein the inkjet printhead cartridge is fixed with respect to a main scanning direction of the print medium and the at least one nozzle unit moves in the main scanning direction.

17. The apparatus of claim 16, wherein the inkjet printhead cartridge further comprises:
a shifting unit to move the at least one nozzle unit in the main scanning direction.

18. The apparatus of claim 17, wherein the shifting unit reciprocates the at least one nozzle unit in the main scanning direction.

19. The apparatus of claim 17, wherein the shifting unit comprises:
an actuator to move each nozzle unit in a first direction;
an elastic member to elastically bias each nozzle unit in a second direction opposite the first direction; and
a guide to guide the movement of the at least one nozzle unit.

20. The apparatus of claim 17, wherein the at least one movable nozzle unit comprises a first movable nozzle unit and a second movable nozzle unit, and the shifting unit comprises:
an actuator to move the first movable nozzle unit in a first direction;
a linking unit to move the second movable nozzle unit in a direction opposite to the first direction according to a movement of the first movable unit;
an elastic member to elastically bias the second movable nozzle unit in towards the linking unit; and
a guide to guide the movement of the first and second nozzle units.

21. The apparatus of claim 17, wherein the at least one movable nozzle unit comprise a first movable nozzle unit and a second movable nozzle unit, and the nozzles are disposed in head units, and each of the first and second movable nozzle units comprises at least one head unit.

22. The apparatus of claim 17, wherein the at least one movable nozzle unit comprise a first movable nozzle unit and a second movable nozzle unit, and the first and second movable nozzle units each comprises a plurality of head units, and the head units are arranged in a zigzag pattern.

23. The apparatus of claim 17, wherein the at least one movable nozzle unit comprise a first movable nozzle unit and a second movable nozzle unit, and the first and second movable nozzle units reciprocate with an amplitude equal one-half or less a distance between corresponding head units of the first and second movable nozzle units.

24. The apparatus of claim 16, wherein the at least one nozzle unit moves in the main scanning direction to compensate for a defective nozzle.

25. The apparatus of claim 16, wherein the at least one nozzle unit moves in the main scanning direction to decrease a distance between positions at which ink is ejected through the nozzles to increase a print resolution.

26. An inkjet printhead cartridge usable in an array type image forming apparatus, comprising:
a body;
a plurality of nozzle units movably disposed in the body; and
a plurality of head units having nozzles disposed therein mounted on the nozzle units, and disposed to move with respect to the body.

27. The inkjet printhead of claim 26, further comprising:
a shifting unit to move the nozzle units with respect to the body.

28. The inkjet printhead cartridge of claim 26, further comprising:
a shifting unit to move the nozzle units with respect to each other.
